(19) United States
(12) Patent Application Publication
(10) Pub. No.: US 2014/0103024 A1
(43) Pub. Date: Apr. 17, 2014

(54) HEATER DEVICE AND HEAT TREATMENT APPARATUS

(71) Applicant: Tokyo Electron Limited, Tokyo (JP)

(72) Inventor: Makoto Kobayashi, Iwate (JP)

(73) Assignee: Tokyo Electron Limited, Tokyo (JP)

(21) Appl. No.: 14/044,011

(22) Filed: Oct. 2, 2013

(30) Foreign Application Priority Data
Oct. 12, 2012 (JP) 2012-227187

(51) Int. Cl. F27D 11/02

(52) U.S. Cl. CPC F27D 11/02
USPC 219/402

(57) ABSTRACT

Proposed is a heater device in which heater elements are suppressed from coming in contact with each other. The heater device includes: a cylindrical insulating layer; one or more heater elements which are spirally wound plural times and disposed on an inner periphery side of the insulating layer; a plurality of holding members configured to extend along an axial direction of the insulating layer and support the heater elements at a predetermined pitch at the inner periphery side of the insulating layer; and projections provided on the insulating layer at positions that correspond to the wound heater elements between holding members which are adjacent in a circumferential direction of the insulating layer.

### CROSS-REFERENCE TO RELATED APPLICATIONS

This application is based on and claims priority from Japanese Patent Application No. 2012-227187, filed on Oct. 12, 2012, with the Japan Patent Office, the disclosure of which is incorporated herein in its entirety by reference.

### TECHNICAL FIELD

The present disclosure relates to a heater device and a heat treatment apparatus.

### BACKGROUND

For example, in manufacturing a semiconductor device, processes such as, for example, a deposition process, an oxidation process, a diffusion process, an annealing process, and an etching process are performed on a semiconductor wafer which is an object to be processed. In general, when performing these processes, various heat treatment apparatuses are used which include a processing container configured to accommodate an object to be processed, and a heater device disposed at an outer periphery side of the processing container to surround the processing container. See, e.g., Japanese Patent Laid-Open Publication No. 2000-182979.

The heater device is formed by winding resistance heating elements (heater elements), for example, in a spiral form, at an inner periphery side of an insulating layer having, for example, a cylindrical shape. In general, the pitch of the spiral heater elements (interval between axially adjacent heater elements) is designed to range, for example, from about 10 mm to 30 mm.

### SUMMARY

A heater device according to the present disclosure includes: a cylindrical insulating layer; one or more heater elements which are spirally wound plural times and disposed on an inner periphery side of the insulating layer; a plurality of holding members configured to extend along an axial direction of the insulating layer and support the heater elements at a predetermined pitch at the inner periphery side of the insulating layer; and projections provided on the insulating layer at positions that correspond to the wound heater elements between holding members which are adjacent in a circumferential direction of the insulating layer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic configuration view illustrating a heater device according to an aspect of the present disclosure and a heat treatment apparatus provided with the heater device.

FIG. 2 is an enlarged schematic view illustrating a portion around heater elements of the heater device of the aspect.

FIGS. 3A and 3B are schematic views illustrating a conventional heater device. FIGS. 3A and 3B are represented in order to describe a problem of the conventional heater device in which FIG. 3A is a schematic plan view illustrating the conventional heater device, and FIG. 3B is a schematic radial cross-sectional view illustrating the conventional heater device.

FIG. 4 is a schematic view illustrating a heater device according to a first exemplary embodiment.

FIGS. 5A and 5B are schematic views illustrating another example of the heater device according to the first exemplary embodiment.

FIGS. 6A and 6B are schematic views illustrating a heater device according to a second exemplary embodiment.

FIGS. 7A and 7B are schematic views illustrating a heater device according to a third exemplary embodiment.

FIG. 8 is a schematic view illustrating a heater device according to a fourth exemplary embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other modifications may be made without departing from the spirit or scope of the subject matter presented here.

A heater element used in a heater device is subject to creep strain by being repeatedly used at a high temperature, and its line length is elongated with elapse of time. When an excess length that occurs in the heater element due to the elongation of the line length of the heater element (hereinafter, referred to as permanent elongation) is bent, axially adjacent heater elements come in contact with each other, thereby causing a short-circuiting. Also, the heater element may be broken due to stress caused by deformation, such as thermal expansion and contraction, occurring according to heating and cooling of the heater element, as well as permanent elongation.

In consideration of the above described problems, there is provided a heater device in which heater elements may be suppressed from coming in contact with each other.

A heater device according to an aspect of the present disclosure includes a cylindrical insulating layer; one or more heater elements which are spirally wound plural times and disposed on an inner periphery side of the insulating layer; a plurality of holding members configured to extend along an axial direction of the insulating layer and support the heater elements at a predetermined pitch at the inner periphery side of the insulating layer; and projections provided on the insulating layer at positions that correspond to the wound heater elements between holding members which are adjacent in a circumferential direction of the insulating layer.

In the heater device, the projections are formed in a rib shape along the axial direction of the insulating layer.

In the heater device, the projections are formed in the axial direction of the insulating layer at a predetermined pitch.

In the heater device, the projections are formed at a center between the holding members which are adjacent in the circumferential direction

The heater device further include a contact prevention member provided between heater elements which are adjacent in the axial direction

In the heater device, the contact prevention member is a board that is inserted into the insulating layer and extends in the circumferential direction and radial direction of the insulating layer.

In the heater device, an inner circumferential surface of the insulating layer that faces the heater elements is formed in a recessed arc shape.

In the heater device, each of the holding members includes a base portion positioned inside of the heater elements, and a support portion which is formed to extend from the base portion toward radial outside of the insulating layer through a space between adjacent heater elements and inserted into the insulating layer, in which the base portion of the heater element side is formed in a recessed arc shape which recessed on the heater element side thereof.

In the heater device, a distance obtained by subtracting a diameter of the heater elements from a distance from the base portion to the insulating layer is a thermal expansion amount or more at a use temperature of the heater device.

A heat treatment apparatus according to another aspect of the present disclosure, a heat treatment apparatus including: a processing container configured to accommodate an object to be processed; and the above described heater device, which is disposed at an outer periphery of the processing container to surround the processing container.

There is provided a heater device in which heater elements are suppressed from coming in contact with each other.

Hereinafter, exemplary embodiments of the present disclosure will be described with reference to accompanying drawings.

(Heater Device and Heat Treatment Apparatus)

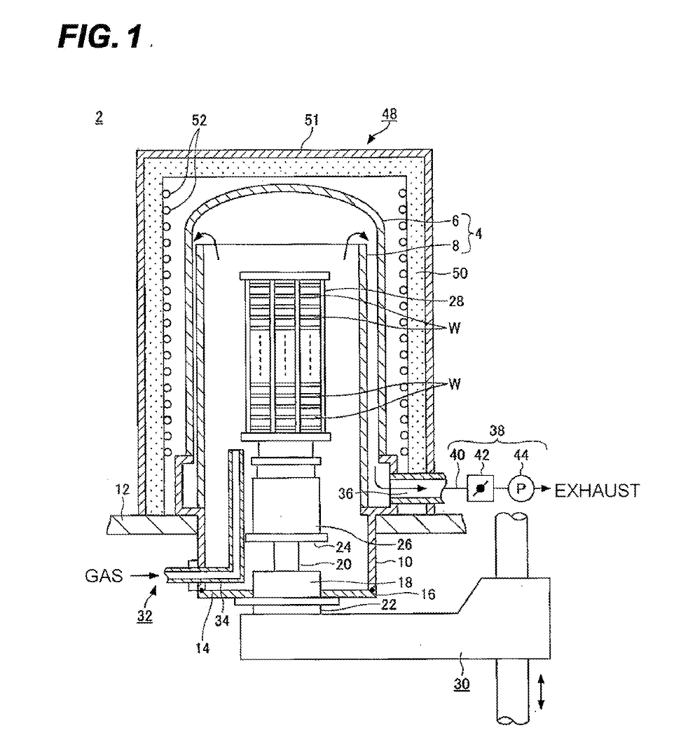

First, an example of a basic configuration of a heater device according to an aspect of the present exemplary embodiment, and a heat treatment apparatus provided with the heater device will be described. FIG. 1 is a schematic configuration view illustrating a heater device according to an aspect of the present disclosure and the heat treatment apparatus that is provided with the heater device. Herein, an exemplary heater device and an exemplary vertical heat treatment apparatus including such a heater device for forming a semiconductor device will be described. However, the present disclosure is not limited thereto, and may include other various types of heater devices and heat treatment apparatuses including such heater devices.

As illustrated in FIG. 1, a vertical heat treatment apparatus 2 has a processing container 4 of which the longitudinal direction is the vertical direction. The processing container 4 is configured in a double-tube structure that has an outer tube 6 with a ceiling, and a cylindrical inner tube 8 which is concentrically disposed inside the outer tube 6.

The outer tube 6 and the inner tube 8 are made of a heat resistant material such as, for example, quartz. The bottom of the outer tube 6 and the inner tube 8 is held by a manifold 10 made of such as, for example, stainless steel. The manifold 10 is fixed on a base plate 12. Alternatively, the processing container 4 may be formed of, for example, quartz, in its entirety without being provided with the manifold 10.

A disk-shaped cap portion 14 made of, for example, stainless steel is hermetically sealably attached at an opening of the bottom of the manifold 10 through a sealing member 16 such as, for example, an 0-ring. A rotation shaft 20 that is rotatable in an airtight state by, for example, a magnetic fluid seal 18 is inserted into the substantially central portion of the cap portion 14. A rotation mechanism 22 is connected to the lower end portion of the rotation shaft 20, and a table 24 made of, for example, stainless steel is fixed to the upper end portion of the rotation shaft 20.

A heat insulating tube 26 made of, for example, quartz is provided on the table 24. Also, a wafer boat 28 made of, for example, quartz is mounted as a support on the heat insulating tube 26.

In the wafer boat 28, for example, 50 to 150 sheets of semiconductor wafers W as objects to be processed are accommodated at a predetermined interval, for example, a pitch of about 10 mm. The wafer boat 28, the heat insulating tube 26, the table 24 and the cap portion 14 are loaded to and unloaded from the inside of the processing container 4 by an elevating mechanism 30 such as, for example, a boat elevator, in an integrated manner.

A gas introducing module 32 configured to introduce a processing gas into the processing container 4 is provided at a lower portion of the manifold 10. The gas introducing module 32 has a gas nozzle 34 that is provided to airtightly penetrate the manifold 10.

Although one gas introducing module 32 is provided in the configuration illustrated in FIG. 1, the present disclosure is not limited thereto. A heat treatment apparatus may have a plurality of gas introducing modules 32 depending on, for example, the number of gas species to be used. The flow rate of a gas to be introduced from the gas nozzle 34 to the processing container 4 is controlled by a flow control mechanism (not illustrated).

A gas outlet 36 is provided at an upper portion of the manifold 10, and an exhaust system 38 is connected to the gas outlet 36. The exhaust system 38 includes an exhaust passage 40 connected to the gas outlet 36, and a pressure control valve 42 and a vacuum pump 44 which are sequentially connected in the middle of the exhaust passage 40. The atmosphere within the processing container 4 may be exhausted by the exhaust system 38 while being subjected to pressure control.

A heater device 48 that surrounds the processing container 4 to heat an object to be processed such as a wafer W is provided over the outer periphery side of the processing container 4.

The heater device 48 has an insulating layer 50 formed in a cylindrical shape having a ceiling surface. The insulating layer 50 is made of, for example, a mixture of soft and amorphous silica and alumina each having a low thermal conductivity. Hereinafter, in the present specification, “axial direction”, “circumferential direction” and “radial direction” indicate an axial direction, a circumferential direction and a radial direction of the insulating layer 50 formed in the cylindrical shape, respectively.

The insulating layer 50 is disposed such that the inner periphery thereof is spaced apart from the outer surface of the processing container 4 by a predetermined distance. A protective cover 51 made of, for example, stainless steel is attached to the outer periphery of the insulating layer 50 to cover the outer periphery of the insulating layer 50 in its entirety.

Heater elements 52 are spirally wound and disposed on the inner periphery side of the insulating layer 50. Disposition of the heater elements 52 schematically illustrated in FIG. 1 will be described in detail below.

The heater elements 52 are provided by being wound on the inner periphery side of the insulating layer 50 over the entire side surface in the axial direction.

The heater elements 52 are divided into a plurality of zones (e.g., four zones) in the axial direction. The heater elements 52 are configured such that a temperature of each zone may be independently and individually controlled by a control unit (not illustrated) based on a temperature detected by a thermocouple (not illustrated) provided on the insulating layer 50.

An element length of the spirally wound heater elements 52 depends on the size of the heat treatment apparatus, but generally ranges from about 15 m to 50 m. Thus, when a permanent elongation of, for example, 1.5%, occurs by aged deterioration of the heater elements, a permanent elongation in a range from 225 mm to 750 mm occurs. Accordingly, from the viewpoint of, for example, the long-life of a heat treatment apparatus, it is very important for a heat treatment apparatus to have a structure which may avoid the elongation of heater elements.

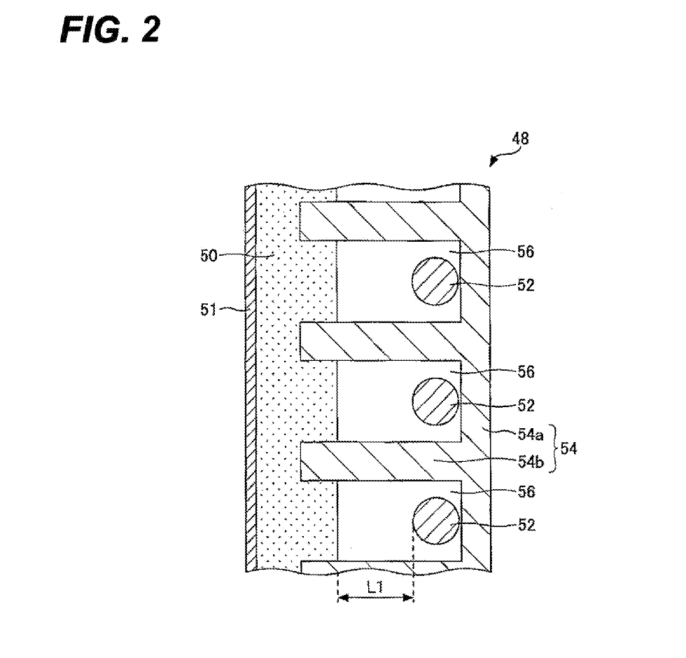

FIG. 2 is an enlarged schematic view illustrating a portion around heater elements of the heater device of the present aspect. The heater device 48 has a holding member 54 made of a ceramic material which is an insulating material. The holding member 54 is provided on the inner circumferential surface side of the insulating layer 50, and outside the outer tube 6 of FIG. 1.

As illustrated in FIG. 2, the holding member 54 is formed in, for example, a comb shape, which has a base portion 54a positioned at an inner side than the heater elements 52, and a plurality of support portions 54b that extend from the base portion toward the radial outside of the insulating layer 50 through the intervals between the heater elements 52. Some of the support portions 54b are connected to the insulating layer 50, and the heater elements 52 are accommodated within holding portions 56 each of which is a region surrounded by two axially adjacent support portions 54b, the base portion 54a and the insulating layer 50. A plurality of holding members 54 are disposed along the circumferential direction of the insulating layer 50 at, for example, a predetermined interval. The configuration where the heater device 48 has the holding portions 56 may suppress positional displacement of the heater elements 52. The interval between two circumferentially adjacent holding members 54 depends on the size of the heater device 48, and may range, for example, from about 50 mm to about 150 mm. The axial pitch of the heater elements 52 ranges, for example, from about 10 mm to about 30 mm, and the diameter of the cross-section of the heater elements ranges, for example, from about 1 mm to about 10 mm.

(Conventional Problem)

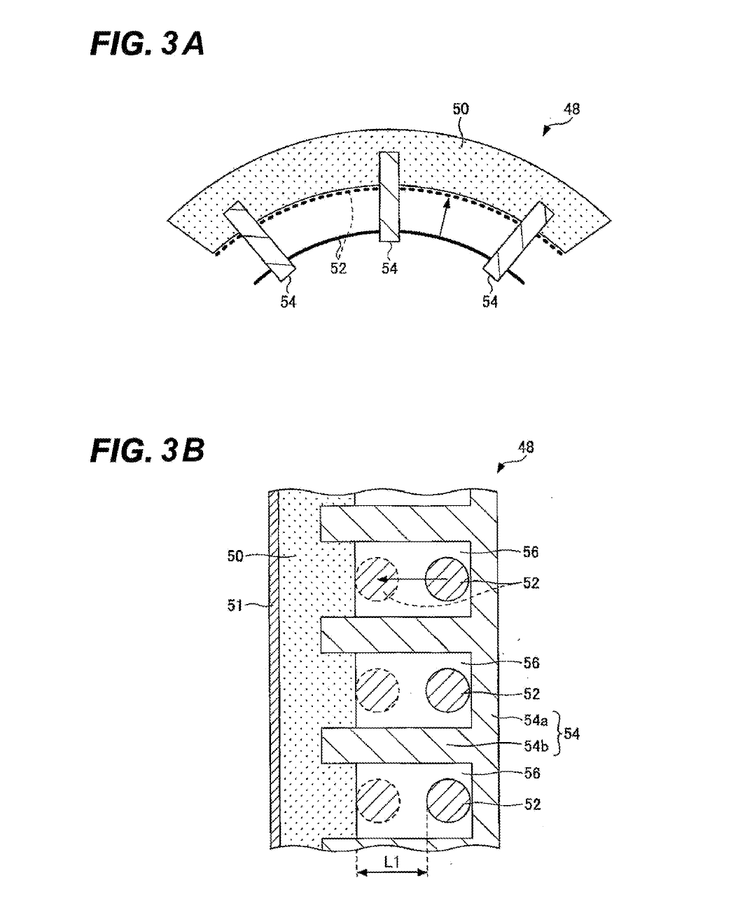

FIGS. 3A and 3B are schematic views illustrating a conventional heater device. FIGS. 3A and 3B are represented in order to describe a problem of the conventional heater device. FIG. 3A is a schematic plan view illustrating the conventional heater device, and FIG. 3B is a schematic radial cross-sectional view illustrating the conventional heater device.

In FIGS. 3A and 3B, the solid lines indicate the disposition positions of the heater elements 52 before using the heater device 48. The line length of the heater elements 52 are elongated by long-term use of the heater device 48, and thus a gap is provided in advance between the heater elements 52 and the insulating layer 50. At the time of manufacturing, the distance between the insulating layer 50 and the heater elements 52 (length L1 in FIG. 3B)(also referred to as a clearance) is set to be about a thermal expansion amount at a use temperature, specifically, in a range of from about 3 mm to 10 mm in consideration of, for example, the size or use temperature of the heater device 48. Until the heater elements 52 come in contact with the insulating layer 50, displacement of the heater elements 52 by thermal expansion and contraction according to heating and cooling are allowed by the clearance. In other words, the clearance L1 may be a length obtained by subtracting the diameter of the heater elements 52 at the time of manufacturing from the distance from a base portion 54a to the insulating layer 50.

In FIGS. 3A and 3B, the dash lines indicate an example in which the heater elements 52 are disposed after the long-term use of the heater device 48. Since the line length of the heater elements 52 is elongated by long-term use of the heater device 48, the heater elements 52 move outward radially on the holding member 54 to come in contact with the insulating layer 50. In that state, when the line length of the heater elements 52 is further elongated, the heater elements 52 are deformed because there is no free space for elongation in the radial direction. When the deformation of the heater elements is progressed by further using the heater device 48, there is a problem in that axially adjacent heater elements 52 come in contact with each other to be short-circuited.

Hereinafter, descriptions will be made on the configurations of heater devices according to exemplary embodiments of the present disclosure which may solve the conventional problems as described above.

### First Exemplary Embodiment

An exemplary embodiment of a heater device that may suppress contact between heater elements will be described with reference to drawings.

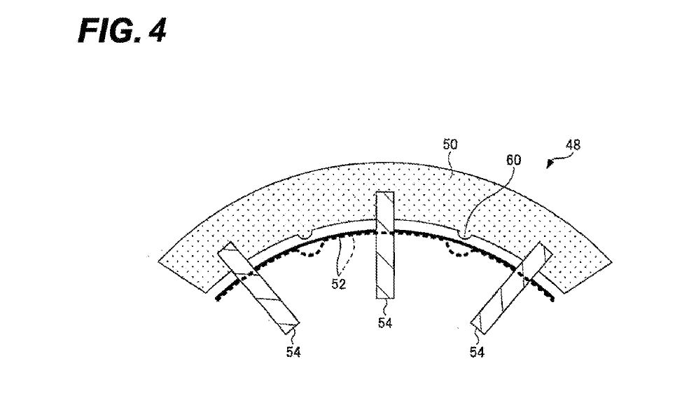

FIG. 4 is a schematic view illustrating a heater device according to a first exemplary embodiment. As illustrated in FIG. 4, the heater device 48 of the first exemplary embodiment has projections 60 provided on the insulating layer 50. The projections 60 are provided at positions that correspond to the wound heater elements 52 between the circumferentially adjacent holding members 54.

In FIG. 4, the solid line indicates a heater element 52 just before the heater element 52 comes in contact with the projections 60, and the dash line indicates a heater element 52 after the heater element 52 comes in contact with the projections 60. Since the heater device 48 has the projections 60, the deformation of the heater element 52 is directed toward the radial inside. Accordingly, even if the deformation of the heater elements 52 is progressed by further using the heater device 48, a possibility that axially adjacent heater elements 52 come in contact with each other may be reduced because the elongation in the axial direction is suppressed.

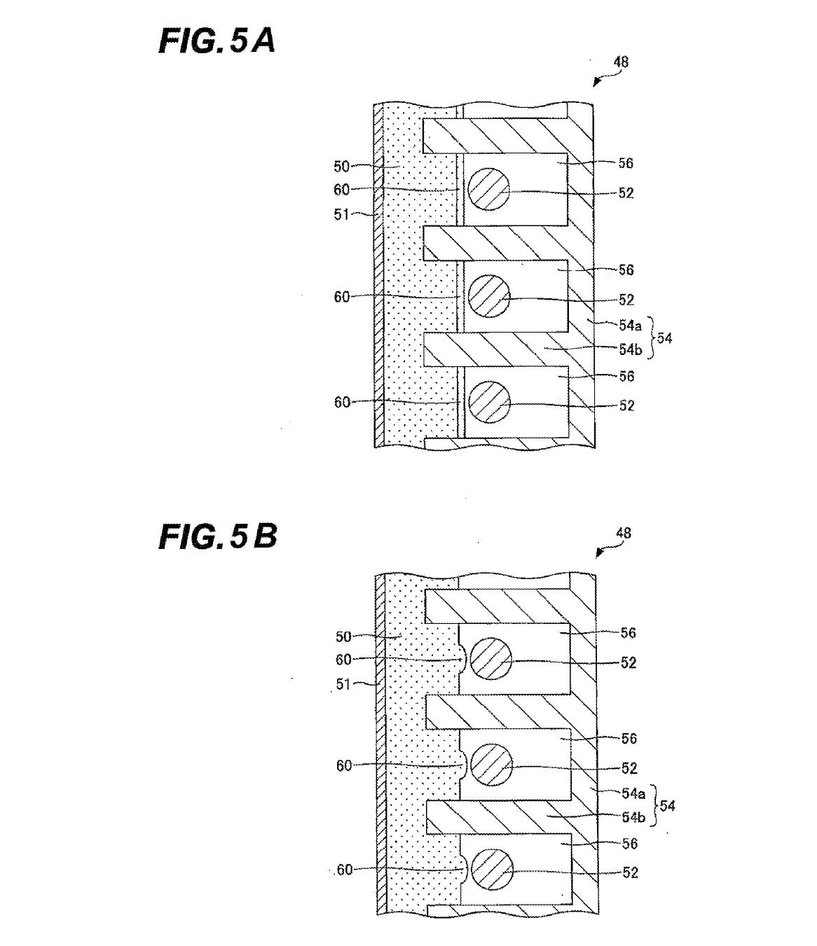

In the present exemplary embodiment, the distribution form of the projections 60 is not especially limited as long as the heater device 48 has the projections 60 between circumferentially adjacent holding members 54 and at positions corresponding to the wound heater elements 52 on the insulating layer 50. FIGS. 5A and 5B are schematic views illustrating another example of the heater device according to the present exemplary embodiment so as to describe the shapes of the projections 60.

In the exemplary embodiment of FIG. 5A, the projections 60 are formed in a rib shape along the axial direction of the insulating layer 50. Meanwhile, as illustrated in the exemplary embodiment of FIG. 5B, the projections 60 may be formed at pitches of the heater elements 52, respectively. However, the exemplary embodiment of FIG. 5A is desirable since the heater elements 52 always come in contact with the projections 60 such that deformation of the heater element 52 is directed toward the radial inside even if the heater element 52 is moved in the axial direction due to its own weight or an external factor. Further, the exemplary embodiment of FIG. 5A has an advantage in that the projections 60 may be easily formed when the projections 60 are formed integrally with the insulating layer 50.

The projections 60 may be respectively provided at the centers between adjacent holding members 54 in the circumferential direction of the insulating layer 50 as illustrated in FIG. 4, or may be provided at several positions obtained by equally dividing the interval between every two adjacent holding members 54 in the circumferential direction of the insulating layer 50, by three or more.

The shapes of the projections 60 are not particularly limited as long as the deformation of the heater elements 52 is allowed to be directed toward the radial inside when the heater elements 52 come in contact with the projections 60. For example, when viewed in the axial direction of the insulating layer 50, the cross-sectional shape of the projections 60 may be circular, semi-circular, triangular, or rectangular.

As illustrated in FIGS. 4 and 5A and 5B, the projections 60 may be made of the same material as the insulating layer 50, and formed integrally with the insulating layer 50. Otherwise, the projections 60 may be formed in advance by separate members, and then attached on the insulating layer 50.

Also, as a modified example of the first exemplary embodiment, the heater elements 52 may be deformed in advance to be bent toward the radial inside. Accordingly, even in a case where the heater elements 52 come in contact with the insulating layer 50 [or the projections 60] due to the elongation of the line length of the heater elements 52, the deformation of the heater elements 52 is directed in advance radially inward. Therefore, even when the heater elements 52 are further deformed, axially adjacent heater elements 52 are suppressed from coming in contact with each other.

As described above, the heater device 48 of the first exemplary embodiment has the projections 60 between the circumferentially adjacent holding members 54, at positions corresponding to the wound heater elements 52. Since the heater device 48 has the projections 60, the deformation of the heater elements 52 is directed radially inward after the heater elements 52 come in contact with the projections 60. Accordingly, even if deformation of the heater elements 52 is progressed by further using the heater device 48, a possibility that axially adjacent heater elements 52 come in contact with each other may be reduced because the elongation in the axial direction is suppressed.

### Second Exemplary Embodiment

A heater device according to a second exemplary embodiment which may suppress contact between heater elements will be described with reference to drawings.

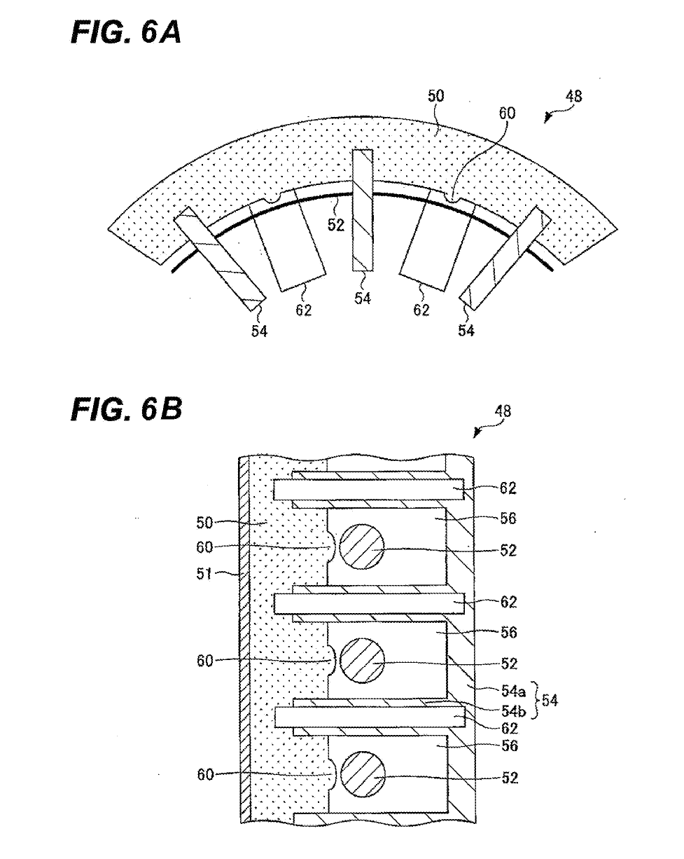

FIGS. 6A and 6B are schematic views illustrating a heater device according to a second exemplary embodiment. More specifically, FIG. 6A is a schematic plan view illustrating the heater device of the second exemplary embodiment, and FIG. 6B is a schematic radial cross-sectional view illustrating the heater device of the second exemplary embodiment.

As illustrated in FIGS. 6A and 6B, the heater device 48 of the second exemplary embodiment includes contact prevention members 62 which are configured to suppress adjacent heater elements 52 in the axial direction of the insulating layer 50 from coming in contact with each other. The contact prevention members 62 are provided between the axially adjacent heater elements.

The contact prevention members 62 may be formed between axially adjacent heater elements, respectively. Thus, for example, in a case where the projections 60 are formed at a predetermined pitch in the axial direction as illustrated in FIG. 5B, the contact prevention members 62 may be formed such that each of the contact prevention members 62 is interposed between axially upper and lower sides of two adjacent projections 60 as illustrated in FIG. 6B. Meanwhile, in the distribution form of the projections 60, a plurality of projections 60 may exist in which it is more desirable that each of the contact prevention members 62 is formed between every two axially adjacent projections.

In a case where the projections 60 are formed in a rib shape as illustrated in FIG. 5A, the contact prevention members 62 may be provided in the region where the projections 60 are not formed, or some of the contact prevention members 62 may be processed so as to engage with the projections 60.

As illustrated in FIGS. 6A and 6B, the contact prevention members 62 may be boards inserted into the insulating layer 50 and extending in the circumferential direction and the radial direction of the insulating layer 50, but the present disclosure is not limited thereto. For example, the contact prevention members 62 may be bars inserted into the insulating layer 50 and extending in the radial direction of the insulating layer. That is, the shape of the contact prevention members 62 is not particularly limited. When viewed in the axial direction of the insulating layer 50, the cross-sectional shape of the contact prevention members 62 may be rectangular, or, for example, circular or semi-circular. Also, each of the contact prevention members 62 may be formed in a hollow body. However, as the area of the cross-section of each of the contact prevention members 62 when viewed in the axial direction of the insulating layer 50 increases, the effect of suppressing axially adjacent heater elements from coming in contact with each other by the contact prevention members 62 increases. Thus, each of the contact prevention members 62 is preferably a board.

The contact prevention members 62 may be made of the same material as the insulating layer 50, and formed integrally with the insulating layer 50. Alternatively, the contact prevention members 62 may be formed by inserting members formed from a different material into the insulating layer 50.

Meanwhile, the heater devices of the first and second exemplary embodiments may be used in combination. That is, the heater device 48 may be configured to have both the projections 60 and the contact prevention members 62.

As described above, in the heater device 48 of the second exemplary embodiment, each of the contact prevention members 62 is provided between axially adjacent heater elements 52. Since the heater device 48 has the contact prevention members 62, axially adjacent heater elements 52 may be suppressed from coming in contact with each other even if the heater elements 52 are deformed in any direction after coming in contact with the insulating layer 50.

### Third Exemplary Embodiment

Hereinafter, a heater device of a third exemplary embodiment of the present disclosure will be described with reference to drawings.

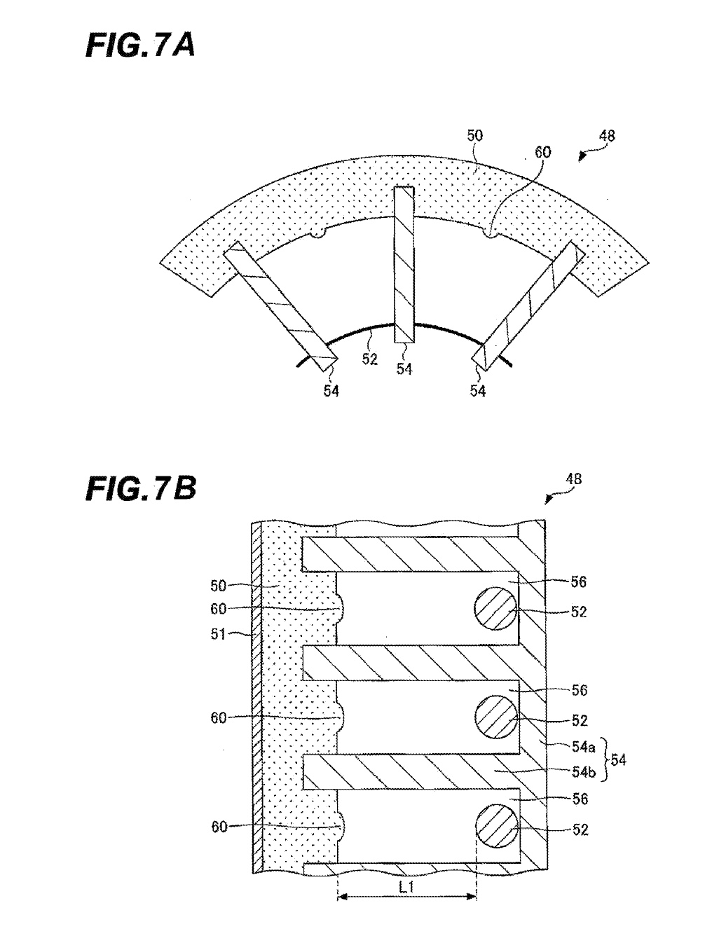

FIGS. 7A and 7B are schematic views illustrating a heater device according to the third exemplary embodiment. More specifically, FIG. 7A is a schematic plan view illustrating the heater device of the third exemplary embodiment, and FIG. 7B is a schematic radial cross-sectional view illustrating the heater device of the third exemplary embodiment.

In the heater device 48 of the third exemplary embodiment, the holding member 54 is elongated in the radial direction, and thus the clearance L1 is longer than that of the conventional heater device. As described above, the clearance L1 is generally set to be about a thermal expansion amount at a use temperature, specifically, in a range of from about 3 mm to 10 mm by taking, for example, the size or use temperature of the heater device 48 into account.

In the heater device 48 of the present exemplary embodiment, the clearance L1 is set to be a thermal expansion amount or more at a use temperature, for example, a range from about 10 mm to 50 mm by taking the permanent elongation of the heater element 52 into account. The prolongation of the clearance L1 may prolong the time margin until the heater element 52 comes in contact with the insulating layer 50. The clearance L1 may be greater than 50 mm, but as the clearance L1 is prolonged, the retention of the heater element 52 becomes difficult. Further, a size increase of the heat treatment apparatus, or a reduction of the (thermal) treatment space may be caused. Thus, it is preferred that the person of ordinary skill in the art appropriately sets the clearance L1 according to desired usages of the heater device 48.

### Fourth Exemplary Embodiment

As a fourth exemplary embodiment, an exemplary embodiment which is preferably combined with the heater device of the above described first and second exemplary embodiments will be described.

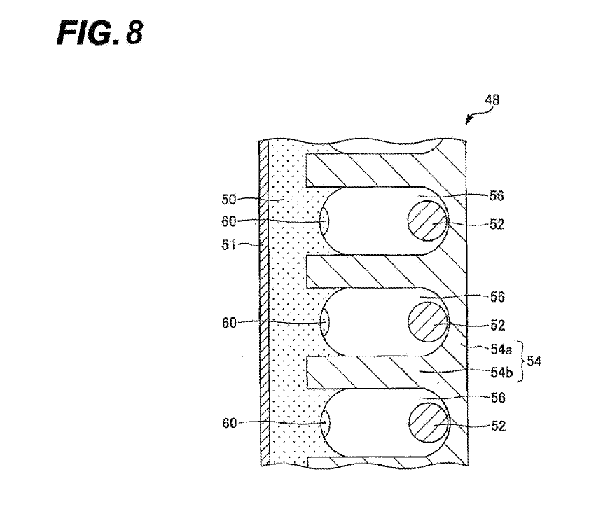

FIG. 8 is a schematic view illustrating a heater device according to the fourth exemplary embodiment.

As illustrated in FIG. 8, the base portion 54a at the heater element 52 side is formed in a recessed shape toward the heater element 52 side, for example, a recessed arc shape which is recessed on the heater element 52 side. Also, in FIG. 8, the inner circumferential surface of the insulating layer 50 that faces the heater element 52 is formed in a recessed shape, preferably a recessed arc shape.

As described above, the shape of the base portion 54a and/or the insulating layer 50 may be designed according to the shape of the heater element, thereby efficiently prolonging the clearance L1.

As described above, in the third and fourth exemplary embodiments, the prolongation of the clearance L1 may prolong the time margin until the heater element 52 comes in contact with the insulating layer 50. By combining third and fourth exemplary embodiments with the first and second exemplary embodiments, a heater device in which heater elements may be suppressed from coming in contact with each other may be provided.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A heater device comprising:
a cylindrical insulating layer;
one or more heater elements which are spirally wound plural times and disposed on an inner periphery side of the insulating layer;
a plurality of holding members configured to extend along an axial direction of the insulating layer and support the heater elements at a predetermined pitch at the inner periphery side of the insulating layer; and
projections provided on the insulating layer at positions that correspond to the wound heater elements between holding members which are adjacent in a circumferential direction of the insulating layer.

2. The heater device of claim 1, wherein the projections are formed in a rib shape along the axial direction of the insulating layer.

3. The heater device of claim 1, wherein the projections are formed in the axial direction of the insulating layer at a predetermined pitch.

4. The heater device of claim 1, wherein the projections are formed at a center between the holding members which are adjacent in the circumferential direction.

5. The heater device of claim 1, further comprising a contact prevention member provided between heater elements which are adjacent in the axial direction.

6. The heater device of claim 5, wherein the contact prevention member is a board that is inserted into the insulating layer and extends in the circumferential direction and radial direction of the insulating layer.

7. The heater device of claim 1, wherein an inner circumferential surface of the insulating layer that faces the heater elements is formed in a recessed arc shape.

8. The heater device of claim 1, wherein each of the holding members includes a base portion positioned inside of the heater elements, and a support portion which is formed to extend from the base portion toward radial outside of the insulating layer through a space between adjacent heater elements and inserted into the insulating layer, wherein the base portion of the heater element side is formed in a recessed arc shape which recessed on the heater element side thereof.

9. The heater device of claim 8, wherein a distance obtained by subtracting a diameter of the heater elements from a distance from the base portion to the insulating layer is a thermal expansion amount or more at a use temperature of the heater device.

10. A heat treatment apparatus comprising:
a processing container configured to accommodate an object to be processed; and
the heater device of claim 1, which is disposed at an outer periphery of the processing container to surround the processing container.
